(19) United States
(12) Patent Application Publication
(10) Pub. No.: US 2025/0096387 A1
(43) Pub. Date: Mar. 20, 2025

(54) ASSEMBLIES FOR PROTECTING BATTERY PACKS OF A VEHICLE

(71) Applicant: Toyota Motor Engineering & Manufacturing North America, Inc., Plano, TX (US)

(72) Inventors: RYAN C. HARRIS, Saline, MI (US); Todd Muck, Fowlerville, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/369,390

(22) Filed: Sep. 18, 2023

(51) Int. Cl. H01M 50/242; B60L 50/64; H01M 10/613; H01M 10/625; H01M 10/6554; H01M 50/229; H01M 50/231; H01M 50/249; H01M 50/262; H01M 50/271

(52) U.S. Cl. CPC H01M 50/242; H01M 10/613; H01M 10/625; H01M 10/6554; H01M 50/229; H01M 50/231; H01M 50/249; H01M 50/262; H01M 50/271; B60L 50/64; H01M 2220/20

(57) ABSTRACT

A battery pack assembly includes a frame, a cooling plate, a plurality of cross members, a plurality of reinforcement members, and a protection plate. The frame includes a front wall, a rear wall, and a pair of side walls. The plurality of cross members extend between the pair of side walls and is coupled to the cooling plate. The plurality of reinforcement members positioned below and coupled to the cooling plate are aligned with the plurality of cross members. The protection plate includes energy absorbing portions and bonded portions. The energy absorbing portions positioned between the plurality of reinforcement members include a top sheet, a bottom sheet, and an energy absorbing material positioned between the bottom sheet and the top sheet. The bonded portions positioned below and coupled to the plurality of reinforcement members include the top sheet and the bottom sheet without the energy absorbing material.

### TECHNICAL FIELD

The present specification generally relates to assemblies for protecting battery packs of a vehicle and, more specifically, assemblies for protecting battery packs of a vehicle which provides sufficient energy absorption in a small space so as to avoid reduction in ground clearance.

### BACKGROUND

As background, vehicles, such as electric or hybrid vehicles, may feature large battery packs to power the drive motors of the vehicle. The battery pack may be placed underneath the vehicle in an area of the vehicle where internal-combustion vehicles may have exhaust pipes, transmissions, fuel tanks, or other components. These battery packs may be susceptible to damage caused by road debris or impact. As such, the battery packs may have a protection plate in order to protect the battery. Current protection plates may be solid plates, which can be heavy. Heavier protection plates can reduce the range and performance of electric vehicles. Further, protection plates that provide sufficient protection may result in reduced ground clearance, or distance between a lower surface of the protection plate and a ground surface, due to a required thickness of the protection plates.

Accordingly, a need exists for improved battery pack protection plates that provides sufficient energy absorption while reducing weight and which avoids a reduction in ground clearance.

### SUMMARY

In one embodiment, a battery pack assembly is disclosed. The assembly includes a frame, a cooling plate, a plurality of cross members, a plurality of reinforcement members, and a protection plate. The frame includes a front wall, a rear wall, and a pair of side walls extending between the front wall and the rear wall. The plurality of cross members extend between the pair of side walls and are coupled to the cooling plate. The plurality of reinforcement members positioned below and coupled to the cooling plate are aligned with the plurality of cross members and extend between the pair of sidewalls. The protection plate includes energy absorbing portions and bonded portions. The energy absorbing portions include a top sheet, a bottom sheet, and an energy absorbing material positioned between the bottom sheet and the top sheet. The bonded portions include the top sheet and the bottom sheet without the energy absorbing material. The energy absorbing portions are positioned between the plurality of reinforcement members and the bonded portions are positioned below and coupled to the plurality of reinforcement members.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a bottom perspective view of a battery pack frame of a vehicle, the battery pack including a cooling plate and a plurality of reinforcing members, according to one or more embodiments described and illustrated herein;

FIG. 1B schematically depicts a bottom perspective view of the battery pack frame of the vehicle with a protection plate, according to one or more embodiments described and illustrated herein;

FIG. 2 schematically depicts a partial perspective view of a cooling plate, a reinforcement member and a protection plate, according to one or more embodiments shown and described herein;

FIG. 3 schematically depicts a partial cross-sectional view of an embodiment of the vehicle frame taken along line III-III of FIG. 1B, according to one or more embodiments described and illustrated herein.

### DETAILED DESCRIPTION

Embodiments described herein are generally directed to a protection plate that includes an energy absorbing portion and a bonded portion. The energy absorbing portion includes a bottom sheet, a top sheet, and an energy absorbing material positioned between the bottom sheet and the top sheet. At the bonded portions, the bottom sheet and the top sheet are bonded without the energy absorbing material positioned below and coupled to a plurality of reinforcement members. The energy absorbing portions are positioned between the plurality of reinforcement members. The bottom sheet, top sheet, and the energy absorbing material are bonded together with an adhesive to create a one piece monolithic structure. The energy absorbing portions taper towards the bonded portions. As such, the absorbing material allows impact force to be distributed over a larger area.

As will be described in additional detail herein, the battery pack includes a cooling plate, a reinforcement member, a protection plate, a battery cover and a plurality of cross member. The cooling plate is coupled between the reinforcement member and the cross member. The cross member and the reinforcement member extend between side walls of the battery pack frame. The battery cover is positioned above the cross member, in the vehicle vertical direction. The reinforcement members are set below the cooling plate in the vehicle vertical direction to provide the battery pack with rigidity and strength. The protection plate is positioned below the cooling plate, the top sheet and bottom sheet bonded together at a point corresponding to the reinforcement member as to create a channel for the reinforcement member. As such, the protection plate does not extend downward in the vehicle vertical direction past the reinforcement member and avoids a lower ground clearance.

Various embodiments of the assembly and the operation of the assembly are described in more detail herein. Whenever possible, the same reference numerals will be used throughout the drawings to refer to the same or like parts.

As used herein, the term “vehicle longitudinal direction” refers to the forward-rearward direction of the vehicle (i.e., in the +/−vehicle X-direction as depicted). The term “vehicle lateral direction” refers to the cross-vehicle direction of the vehicle (i.e., in the +/−vehicle Z-direction as depicted), and is transverse to the vehicle longitudinal direction. The term “vehicle vertical direction” refers to the upward-downward direction of the vehicle (i.e., in the +/−vehicle Y-direction as depicted). Further, the terms “upward,” “downward,” “rearward,” and “forward” are used to describe the relative positioning of various components of the vehicle relative to one another. Because the vehicle structures may be generally symmetrical about the vehicle centerline, the terms “upward,” “downward,” “rearward,” and “forward” may be switched when evaluating components positioned along opposite sides of the vehicle. Further, while certain components of the vehicle are described as extending in one of the identified directions or oriented toward one of the identified directions, it should be understood that these components extend or are oriented in at least these recited directions.

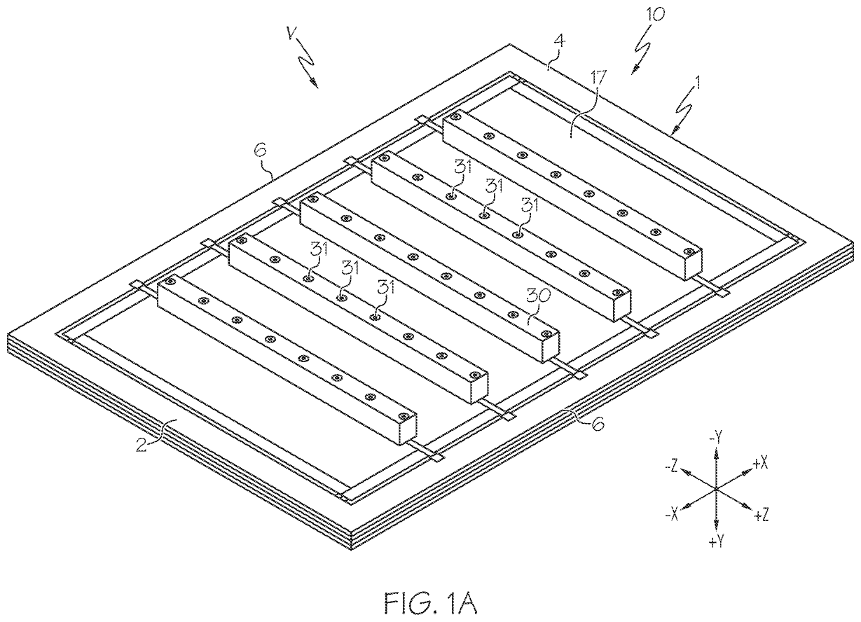

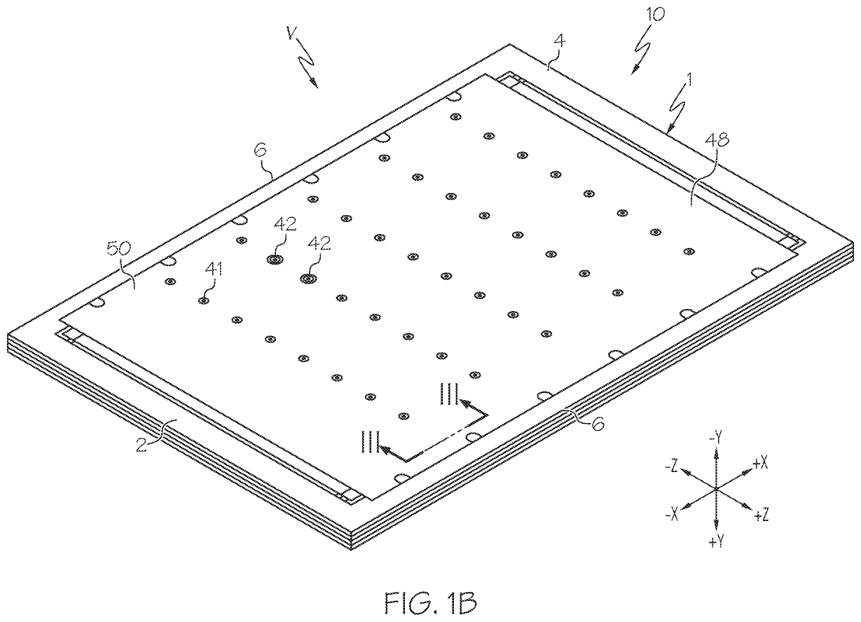

Referring now to FIGS. 1A and 1B, a vehicle V having a battery pack assembly 10 is illustrated. The vehicle V may be an electric vehicle, a hybrid vehicle, or any other type of vehicle. The battery pack assembly 10 includes a battery pack frame 1 having a front wall 2, a rear wall 4, and a pair of side walls 6 that extend between ends of the front wall 2 and the rear wall 4. The pair of side walls 6 extend in the vehicle longitudinal direction. While the pair of side walls 6 are illustrated as having a substantially rectangular cross-section, it should be understood that the side walls 6 may have any suitable cross-section, including but not limited to a circle or an oval.

As further depicted in FIGS. 1A and 1B, the front wall 2 is arranged frontward of the rear wall 4, but it should be understood that the front wall 2 and the rear wall 4 may similarly be arranged in a reversed orientation without departing from the scope of the present disclosure. In these embodiments, the front wall 2, the rear wall 4, and the pair of side walls 6 may be formed of aluminum, steel (e.g., cold rolled steel) or any similar material.

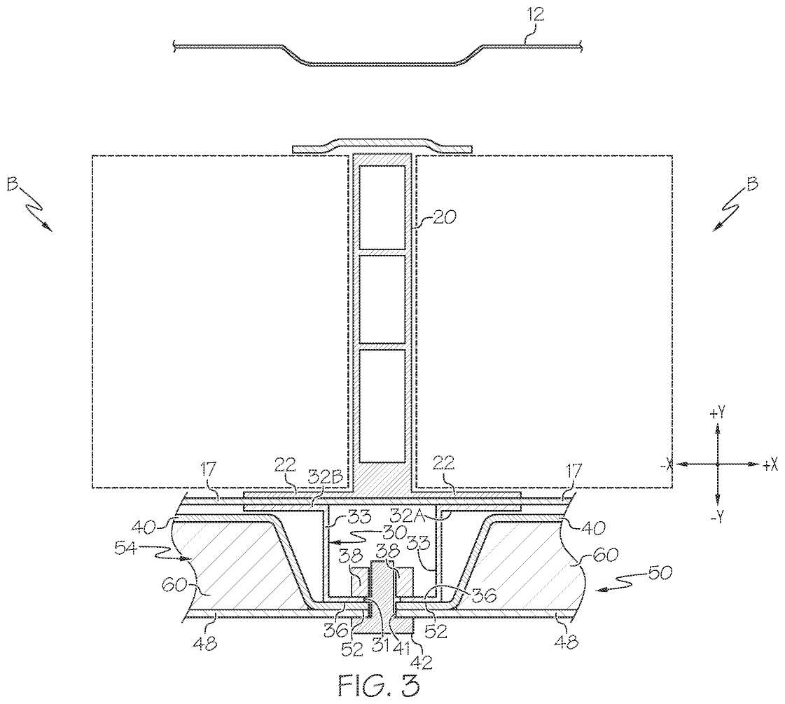

As discussed in greater detail below, the battery pack assembly 10 includes a plurality of cross members 20 and a plurality of batteries B located between adjacent cross members 20, as shown in FIG. 3. The battery pack assembly 10 is located between the pair of side walls 6. The battery pack assembly 10 may be placed in an area of the vehicle V where exhaust pipes, transmissions, fuel tanks, and/or other components are conventionally mounted on internal combustion engine vehicles. However, it should be understood that the battery pack assembly 10 may be mounted in any suitable location on the vehicle V.

The battery pack assembly 10 includes a cooling plate 17 that extends between the front wall 2, the rear wall 4, and the pair of side walls 6. In embodiments, the cooling plate 17 is configures to cool the plurality of batteries B disposed within the battery pack assembly 10.

Referring still to FIG. 1A, the battery pack assembly 10 includes a plurality of reinforcement members 30 that extend between the pair of side walls 6 in the vehicle lateral direction. In embodiments, the plurality of reinforcement members 30 are coupled to the cooling plate 17 via spot welding. In some embodiments, the reinforcement members 30 are coupled to a frame of the vehicle V. Each of the reinforcement members 30 include a plurality of apertures 31 and connection members 38. In embodiments, the plurality of apertures 31 are configured to allow for access to remove and service parts of the battery pack assembly 10.

Referring now to FIGS. 1B and 3, the battery pack assembly 10 includes a protection plate 50 that is coupled to the plurality of reinforcement members 30 by engagement of a plurality of fasteners 42 with the connection members 38 of the plurality of reinforcement members 30. As described in more detail below, the protection plate 50 may be constructed of any suitable material, including but not limited to steel, aluminum, and/or composite materials such as carbon fiber. In some embodiments, the protection plate 50 may be formed of a continuous fiber reinforced resin material. In some embodiments, the protection plate 50 may include a resin composite material and one or more fibers extending in one direction. As a non-limiting example, the one or more fibers may be glass fibers such as continuous glass fibers. As another non-limiting example, the one or more fibers may be glass fibers and nylon fibers (e.g., 95% of the one or more fibers are glass fibers, and 5% of the one or more fibers are nylon fibers). The one or more fibers may be configured to reinforce the resin composite material (e.g., resins such as epoxy, polyester, etc.) of the protection plate 50. As such, the glass fibers may increase a tensile strength, flex modulus, impact resistance, and dimensional stability of the protection plate 50. In further embodiments, the protection plate 50 is formed of a continuous glass fiber reinforced resin material.

Referring now to FIG. 3, the protection plate 50 includes a top sheet 40, an opposite bottom sheet 48, and an energy absorbing material 60 between the top sheet 40 and the bottom sheet 48. The top sheet 40 may be directed to face the cooling plate 17. The bottom sheet 48 may be substantially flat in shape. As illustrated, the protection plate 50 is substantially rectangular, but it should be understood that in embodiments the protection plate 50 may be any suitable shape. In embodiments, the protection plate 50 has a plurality of plate apertures 41. The fasteners 42 extend through the plate apertures 41 and apertures 31 to engage the connection members 38 to couple the protection plate 50 to the plurality of reinforcement members 30.

In embodiments the energy absorbing material 60 may be a dense foam material. The energy absorbing material 60 may be an open cell foam or a closed cell foam. In some embodiments, the energy absorbing material 60 is an expandable adhesive foam, where, upon bonding, the top sheet 40, the bottom sheet 48, and the energy absorbing material 60 may be configured to act as a one piece monolithic structure when a load is applied.

In embodiments, for example, the energy absorbing material 60 may be high energy absorption foam, such as a polyurethane foam. In these embodiments, the energy absorbing material 60 may have a density between 0.1-1.0 g/cm³, such as between 0.1-0.7 g/cm3. In other embodiments, the energy absorbing material 60 may include a structural foam, such as a polyamide particle foam. In these embodiments, the energy absorbing material 60 may have a density between 250-400 g/L, such as between 290-350 g/L. However, it should be understood that the embodiments described herein are intended to be exemplary in nature, and the energy absorbing material 60 may include any material of any density without departing from the scope of the present disclosure. Further, in embodiments, it should be understood that multiple energy absorbing materials may be used within the protection plate 50.

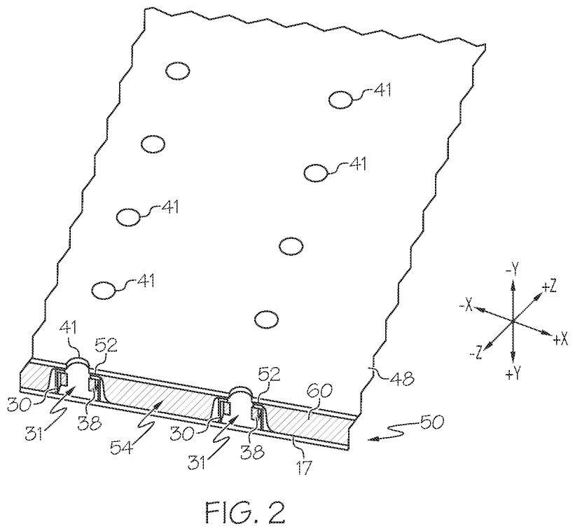

Now referring to FIG. 2, a section of the cooling plate 17, the reinforcement member 30 and protection plate 50 is depicted. The top sheet 40 of protection plate 50 includes a bonded portion 52 where the top sheet 40 is coupled to the bottom sheet 48 of the protection plate 50. At the bonded portion 52, the energy absorbing material 60 is not included between the top sheet 40 and the bottom sheet 48. The protection plate 50 further includes an energy absorption portion 54 opposite the bonded portion 52, positioned between adjacent reinforcement members 30. At the energy absorption portion 54, the protection plate 50 includes the top sheet 40, bottom sheet 48, and energy absorbing material 60. In embodiments, a height, in the vehicle vertical direction, of the protection plate 50 tapers towards the bonded portion 52.

In embodiments, the top sheet 40 and bottom sheet 48 may be configured to be bonded to form a corrugated pattern between the adjacent reinforcement members 30. In such embodiments, the top sheet 40 is coupled to the bottom sheet 48 to create pockets of energy absorption material 60. In some embodiments, a thickness of the bottom sheet 48 is greater than the thickness of the top sheet 40.

Now referring to FIG. 3, a partial cross section of the battery pack assembly 10 is illustrated. The battery pack assembly 10 includes the battery cover 12, the plurality of cross members 20, the cooling plate 17, the reinforcement members 30, and the protection plate 50. The cross members 20 are positioned below the battery cover 12 and include two extended portions 22 opposite the battery cover 12. The extended portions 22 of the cross members 20 couples the cross members 20 to the cooling plate 17. In embodiments, the cooling plate 17 and cross members 20 may be coupled with spot welding. In embodiments, the plurality of cross members 20, the cooling plate 17, and the reinforcement member 30 are coupled together with spot welding. In embodiments, located on either side of the cross member 20 there may be a plurality of battery cells B.

The plurality of cross members 20 are positioned below the cooling plate 17 at positions corresponding to the reinforcement members 30. Each of the reinforcement members 30 is a general hat shape that includes a first upper wall 32A, a second upper wall 32B, a lower wall 36 opposite the first upper wall 32A and the second upper wall 32B, and a pair of side walls 33. The first upper wall 32A and second upper wall 32B are coupled to the cooling plate 17. The side walls 33 extend between the lower wall 36 and the first upper wall 32A and second upper wall 32B, respectively. The lower wall 36 includes the plurality of apertures 31 formed therein. The connection members 38 are provided above the lower wall 36 and at a position corresponding to the apertures 31.

The protection plate 50 is fixed to the battery pack assembly 10 by the fasteners 42. Specifically, the protection plate 50 is positioned with respect to the plurality of reinforcement members 30 such that the plate apertures 41 align with the apertures 31. Next, the fasteners 42 are inserted through the plate apertures 41 of the protection plate 50 and the apertures 31 of the reinforcement member 30 so as to engage the fasteners 42 with the connection members 38 to fix the protection plate 50 to the reinforcement members 30, and, consequently, to the battery pack assembly 10.

In some embodiments, the connection member 38 is a rivet nut or a weld nut. The engagement of the fasteners 42 and the connection member 38 allows the protection plate 50 to be removed for the servicing of the battery pack assembly 10.

As shown in FIG. 3, the top sheet 40 of the protection plate 50 and the bottom sheet 48 of the protection plate 50 are bonded at a position corresponding to the lower wall 36 of the reinforcement member 30 without the energy absorbing material 60 present to create a channel for the reinforcement member 30. Energy absorbing material 60 is present between the top sheet 40 and the bottom sheet 48 as the top sheet 40 moves towards the cooling plate 17 to the energy absorption portion 54. As stated above, the top sheet 40, the bottom sheet 48, and the energy absorbing member 60 are bonded together with an adhesive to produce a one piece monolithic structure. As such, impact force is able to be distributes over a larger area as to prevent damage to the battery case upon impacts without deceasing the ground clearance of the vehicle.

From the above, it is to be appreciated that defined herein is an improved battery pack protection which is maintains rigidity and strength while providing energy absorption in a space to prevent reduction in ground clearance.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A battery pack assembly comprising:
a frame having a front wall, a rear wall, and a pair of side walls extending between the front wall and the rear wall;
a cooling plate;
a plurality of cross members extending between the pair of side walls and coupled to the cooling plate;
a plurality of reinforcement members positioned below and coupled to the cooling plate and aligned with the plurality of cross members to extend between the pair of side walls; and
a protection plate including energy absorbing portions and bonded portions, the energy absorbing portions include a top sheet, a bottom sheet, and an energy absorbing material positioned between the bottom sheet and the top sheet, the bonded portions include the top sheet and the bottom sheet without the energy absorbing material, the energy absorbing portions are positioned between the plurality of reinforcement members and the bonded portions are positioned below and coupled to the plurality of reinforcement members.

2. The battery pack assembly of claim 1, wherein the bottom sheet and top sheet are formed of a composite material.

3. The battery pack assembly of claim 1, wherein the energy absorbing material is a foam material.

4. The battery pack assembly of claim 1, wherein a thickness of the bottom sheet is greater than a thickness of the top sheet.

5. The battery pack assembly of claim 1 further comprising:
a battery cover; and
a cross member positioned above the cooling plate and below the battery cover.

6. The battery pack assembly of claim 1, wherein each of the plurality of cross members includes a plurality of apertures and a plurality of connection members aligned with the plurality of apertures, the protection plate includes a plurality of apertures aligned with the plurality of apertures of the plurality of cross members, and
wherein a plurality of fasteners extend through the plurality of apertures of the protection plate and the plurality of apertures of the plurality of cross members and engage with the plurality of connection members to fix the protection plate to the plurality of cross members.

7. The battery pack assembly of claim 6, wherein the plurality of cross members, the cooling plate, and the reinforcement member are coupled together with spot welding.

8. The battery pack assembly of claim 6, wherein the connection members are rivet-nuts.

9. The battery pack assembly of claim 6, wherein the connection members are weld-nuts, wherein the bottom sheet, the top sheet, and the energy absorbing material are bonded together.

10. The battery pack assembly of claim 1, wherein the energy absorbing portions taper towards the bonded portions.
